(19) United States
(12) Patent Application Publication
(10) Pub. No.: US 2026/0281855 A1
(43) Pub. Date: Sep. 17, 2026

(54) SATELLITE COMMUNICATION SYSTEM UTILIZING CUSTOMIZED HIGHLY ELLIPTICAL ORBITS

(71) Applicant: HEO Satellite, LLC, Charlotte, NC (US)

(72) Inventors: Ryan Stone, Charlotte, NC (US); Andrew Caplan, McLean, VA (US); David Helfgott, Fall Church, VA (US)

(21) Appl. No.: 19/075,846

(22) Filed: Mar. 11, 2025

(51) Int. Cl. H04W 36/08; H04B 7/185; H04B 7/195; H04W 12/06

(52) U.S. Cl. CPC H04W 36/083; H04B 7/18519; H04B 7/195; H04W 12/06

(57) ABSTRACT

A method of applying enhanced communication security in a satellite communication environment may include communicating with a satellite having a highly elliptical orbit from a satellite controller at a ground station, determining an orbital modification to apply to the satellite, communicating a command instruction to the satellite for thrusters of the satellite to provide a micro-orbit adjustment, and monitoring communications after the micro-orbit adjustment to determine malicious actors based on a timing adjustment associated with the micro-orbit adjustment.

### TECHNICAL FIELD

Example embodiments generally relate to wireless communications and, more particularly, relate to enabling the use of satellites with customized highly elliptical orbits (HEO) to optimize communication capability against cost while also enhancing security.

### BACKGROUND

Traditional satellite constellations, which include Low Earth Orbit (LEO), Medium Earth Orbit (MEO), and Geostationary Earth Orbit (GEO) have been used for supporting wireless communication for many years. Each type of constellation carries significant trade-offs in relation to coverage, latency, cost, and lifespan.

In this regard, for example, LEO systems require hundreds or thousands of satellites with short orbital lifespans. LEO systems are known for high bandwidth and low latency. However, the high number of satellites required in the constellation drives up launch, replacement, and operational costs. The relatively short lifespans (5-7 years) of LEO satellites also leads to continual replenishment and expense. LEO systems also require electronically steered antennas, which are complex, and require substantial computational power to handle very frequent handoffs (hard or soft) that occur as receiving devices rapidly transition between the relatively smaller coverage areas of the many satellites in the constellation.

GEO satellites provide nearly global coverage with just a few satellites but suffer from high latency and high costs. In this regard, for example, nearly global coverage can be achieved with as few as three GEO satellites, and the satellite lifespans can exceed 15 years. However, GEO satellites are generally located at extremely high altitudes so that high latency (~250-600 ms roundtrip) can significantly impact the types of communications that can be supported (e.g., inhibiting real time applications). GEO systems typically have large upfront costs to deploy, and redundancy can be limited due to the low number of satellites such that, if one satellite fails, coverage gaps can be significant.

MEO sits in between LEO and GEO in terms of the issues noted above, but often fails to deliver a decisive advantage over either LEO or GEO. In this regard, whereas MEO has a latency that is higher than LEO, it is lower than GEO. Also, whereas MEO satellites have better coverage than LEO satellites, the coverage benefits are still not as comprehensive as GEO. MEO constellations also may face altitude-related coverage issues at extreme latitudes.

Given the limitations of each of the above described systems, and the failure of any one of them to stand out from the crowd in terms of providing superior performance with low cost, there remains room for another entrant into the marketplace. Example embodiments provide a constellation of Highly Elliptical Orbits (HEOs) to achieve low-latency, cost-effective coverage with significantly fewer satellites than traditional LEO constellations.

### BRIEF SUMMARY OF SOME EXAMPLES

In one example embodiment, a satellite communication system may be provided. The system may include a first satellite among a constellation of satellites, where the first satellite has a first HEO with a first apogee and a first perigee. The system may also include a second satellite among the constellation of satellites, where the second satellite has a second HEO with a second apogee and a second perigee. The system may also include a first communication device capable of communicating with the first or second satellite via a first communication link, a second communication device capable of communicating with the first or second satellite via a second communication link and being operably coupled to backhaul and network control components, and a satellite controller operably coupled to the first and second satellites via the second communication device to provide a command instruction to either or both of the first and second satellites to manage a handoff of the first communication device between the first and second satellites or modify an orbit of a respective one of the first or second satellites.

In another example embodiment, a method of applying enhanced communication security in a satellite communication environment may be provided. The method may include communicating with a satellite having a highly elliptical orbit from a satellite controller at a ground station, determining an orbital modification to apply to the satellite, communicating a command instruction to the satellite for thrusters of the satellite to provide a micro-orbit adjustment, and monitoring communications after the micro-orbit adjustment to determine malicious actors based on a timing adjustment associated with the micro-orbit adjustment.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective view of a highly elliptical orbit (HEO) satellite in an orbital plane in accordance with an example embodiment;

FIG. 2 illustrates two HEO satellites in respective orbital planes with the same apogee in accordance with an example embodiment;

FIG. 3 illustrates two HEO satellites in respective orbital planes with the different apogees in accordance with an example embodiment;

FIG. 4 illustrates a system of HEO satellites in accordance with an example embodiment;

FIG. 5 illustrates a perspective view of an aircraft to demonstrate beam aperture and antenna placement in accordance with an example embodiment;

FIG. 6 illustrates a block diagram of a control module in accordance with an example embodiment; and

FIG. 7 illustrates a block diagram of a method of applying enhanced communication security in a satellite communication environment in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, the terms “data,” “content,” “information” and similar terms may be used interchangeably to refer to data capable of being transmitted, received and/or stored in accordance with example embodiments.

In the context of orbital planes, it should be appreciated that the semi-major axis defines the size of the orbit and is the average distance from the center of the Earth to the satellite in its orbit. Eccentricity is typically high for Molniya orbits (e.g., around 0.7), which indicates a very elliptical shape. This allows the satellite to spend a significant amount of time near the apogee, where it moves more slowly. The Molniya orbit is typically inclined at 63.4 degrees relative to the equator. This specific inclination is chosen to minimize the perturbations due to the Earth's equatorial bulge, helping to maintain the stability of the orbit's argument of perigee. The term argument of perigee defines the angle from the ascending node to the orbit's point of closest approach to the Earth (perigee). In Molniya orbits, this is typically set so that the perigee occurs in the southern hemisphere, which positions the apogee over the northern hemisphere for extended periods. This is optimal for coverage over high northern latitudes. The period of revolution is the orbital period of a Molniya satellite, which is about half a sidereal day (approximately 12 hours). This means the satellite completes two orbits per day. This synchronization allows the satellite to revisit the same positions above the Earth at the same times each day, maximizing usability for communication during specific windows. A longitude of ascending node defines the position of the ascending node (where the satellite crosses the equator from south to north) in relation to a fixed reference point, such as the vernal equinox. A true anomaly measures the angle between the perigee and the satellite's current position along its orbit, measured in the direction of the satellite's motion. This parameter is particularly useful for determining the exact position of the satellite in its orbit at any given time. The time of perigee passage refers to the exact time at which the satellite passes closest to the Earth, and is important for precise predictions of the satellite's position and for scheduling communications when the satellite is nearest to the Earth. The term RAAN (Right Ascension of Ascending Node), similar to the longitude of the ascending node, specifies the location of the ascending node in the celestial coordinate system. RAAN is crucial for determining the orbital plane of the satellite, especially in relation to celestial coordinates. Nodal period defines the time it takes the satellite to return to the same node (ascending or descending). This can differ slightly from the orbital period due to the precession of the orbit. The apogee and perigee altitudes define values that are the maximum and minimum distances of the satellite from the Earth's surface, respectively. They are crucial for mission design, as they affect the satellite's coverage area and signal strength at different points in the orbit. Also, perigee velocity and apogee velocity define the speeds of the satellite at perigee and apogee, respectively. These velocities are important for understanding the satellite's dynamics, as it moves faster at perigee and slower at apogee due to its elliptical orbit. Prograde and retrograde orbits are in the same direction as Earth's rotation or in the opposite direction, respectively.

As noted above, example embodiments provide specialized prograde Highly Elliptical Orbits (HEOs), such as Molniya orbits, their inverse (perigee over the North Pole rather than South), and/or all their retrograde counterparts, to achieve low-latency, cost-effective coverage with significantly fewer satellites than traditional LEO constellations. In some cases, example embodiments may further integrate horizon-facing antennas on aircraft or ground antennas in order to enable simpler and more efficient user terminals. Notably, example embodiments can be extended to use for lunar and Martian HEO constellations, offering similar cost, coverage, bandwidth, and latency benefits in those respective contexts.

Beyond merely providing cost and other efficiency improvements, example embodiments may also provide means for implementing security improvements using, for example, physical cryptography (e.g., orbit “micro-adjustments” for data security), physical security of satellites for reduced probability of intercept with orbit micro-adjustments, improved spectrum reuse, and the introduction of a “GEO-HEO hybrid” design (referred to herein as GHEO) to achieve near-real-time communications for Earth, Moon, and/or Mars at a fraction of typical constellations' cost.

HEO constellations, including the most famous example, the Russian Molniya orbits, have been used primarily to provide extended coverage over specific high-latitude regions. A standard Molniya orbit places perigee over the Southern Hemisphere and apogee over the Northern Hemisphere (or vice versa for an inverse Molniya). Due to the characteristics of the HEO in orbit, an extended “hang time” can be maintained over one region (the region being selected by virtue of where the perigee and apogee are located) for communication or remote sensing.

Molniya orbits typically have a period of about 12 hours and a high inclination (e.g., about 63.4 degrees for classic Molniya. The Molniya orbit also has an extended dwell time over a chosen hemisphere, thereby giving the satellite a long visibility for ground stations, aircraft, or other users in the corresponding region. Prior uses of HEO have primarily addressed high-latitude coverage. Little has been disclosed or practiced in terms of systematically adapting HEO for also enabling multi-environment coverage (Earth, Moon, Mars in isolation or in combination), focusing on the benefits of the perigee/near-perigee for coverage (i.e. the opposite of the Molniya orbit's goal), and leveraging specialized antenna configurations or micro-orbit adjustments for security and improved economics

Example embodiments propose an integrated, multi-environment satellite communication system using custom HEO configurations to balance performance (e.g., latency, bandwidth, etc.) with economic feasibility (fewer satellites, less frequent replacement). While leveraging the underlying orbital dynamics of Molniya-type orbits, the system incorporates customized orbit placement. For example, a prograde HEO may be achieved in some cases, where the constellation orbits in the same direction of rotation as the object being orbited, with perigee being near or over the South Pole (i.e. an argument of perigee of ~270 degrees) and a high inclination. This is similar to the traditional Molniya-type orbit with a 63.4 degree inclination. However, inverse prograde HEO, where the constellation orbits with perigee being near or over the North Pole rather than the more typical South Pole, may also be provided when needed or desired for coverage, security, or interference mitigation. Combining both orbit types may ensure continuous high-altitude satellite coverage in the Northern Hemisphere, Southern Hemisphere, and mid-latitudes (equator), and is particularly helpful in providing horizon-facing aircraft antennae with closer satellites; with satellites in both Molniya and reverse Molniya planes, there will be more frequent perigee passes near horizon-facing aircraft. Other HEO planes can also be selected by varying the argument of perigee to put perigee over any desired spot on the object being orbited.

Accordingly, any specific region could be targeted for coverage by selecting perigee and apogee to obtain maximum coverage for the region with a minimum number of HEO satellites. As an example, an oil company exploring for or extracting oil in a particular region (e.g., a particular gulf, bay or other body of water such as, for example, the Gulf of America/Mexico) may define perigee for two orbital planes with three to four satellites per orbital plane to cover the particular region. Ships, oil rigs, and other assets in the particular region may be provided with consistent communication capability via the resultant system at relatively low cost. The regional focus of the constellation may be permanent or temporary, and further launches of satellites may expand the coverage to other regions of interest until all desired coverage up to and including global coverage can potentially be achieved.

As retrograde orbits are a less congested geometry, their use can simplify cross-constellation coordination (i.e. with GEO or non-GEO prograde constellations), especially around sensitive orbits like critical GEO slots. Thus, a typical HEO and inverse HEO that use prograde orbits can also make use of a retrograde orbit, in isolation or combination. These custom HEO constellations can be built incrementally—e.g., starting with 2-6 satellites per orbit plane—to provide immediate regional coverage and then scaling to meet global demand. Prograde and retrograde orbits, when used in combination, may allow for easier frequency sharing if the prograde satellites used complementary frequency assignments or time slots as compared to the retrograde satellites.

Example embodiments may incorporate a reduced satellite count relative to other constellation types, and may still provide near global coverage. By taking advantage of the ~1.5 hours of dwell time at low altitudes on either side of the perigee, coverage can be obtained with significantly fewer satellites compared to traditional LEO constellations yet while retaining near LEO latency for a total of ~3 hours for each satellite in the orbital plane. Thus, with four or more satellites in the orbital plane persistent LEO-like latency can be maintained yet minimizing the number of handoffs needed compared to traditional LEO. As an example, a “GHEO” network (GEO-HEO hybrid) with 8-12 orbital planes and several satellites per orbital plane can be scaled up or down depending on data demand, used in combination with an existing or new GEO satellites, and could be done just regionally versus globally if desired. It should also be appreciated that the timing of dwell time, latency, etc., are all adjustable to fit specific situations or scenarios of interest.

Example embodiments may also incorporate performance and latency advantages relative to other constellation types, and LEO in particular. In this regard, while not having a latency as low as the best LEO networks, the proposed system with HEO satellites remains near or below ~100-250 ms roundtrip for most applications, making it viable for real-time voice, video conferencing, and standard internet usage.

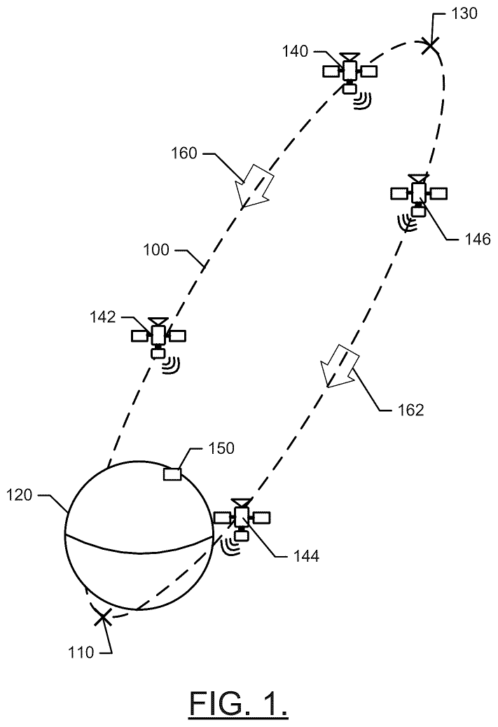

FIG. 1 illustrates a first orbital plane 100 with its perigee 110 near the South Pole of the Earth 120. The first orbital plane 100 may have satellites deployed therein in a HEO. The apogee 130 of the first orbital plane 100 is visible over the northern hemisphere. Four satellites (e.g., a first satellite 140, a second satellite 142, a third satellite 144 and a fourth satellite 146) are shown relatively equally spaced apart in time about the first orbital plane 100. Thus, for example, if a radio receiver 150 is located on a vehicle or on the ground in the northern hemisphere, at least two, and very often three of the four satellites may be visible to the radio receiver and eligible for handoff to maintain continuous connectivity for calls or other communication sessions that the radio receiver 150 conducts with remote servers using the satellite communications system to which the four satellites are operably coupled for communications purposes. As the satellites are near perigee 110, they move very fast, and are therefore out of visibility to the radio receiver 150 for only a relatively short time. However, as the satellites approach, are near to, and proceed away from the apogee 130, they remain in view of the radio receiver 150 for a very long time. As noted above, this provides for a longer dwell time and therefore opportunities for more coverage with fewer satellites. Moreover, the satellites may move in the first orbital plane 100 in either prograde 160 (i.e., the same direction as that of rotation of the Earth 120) or retrograde 162 (i.e., opposite the direction of rotation of the Earth 120).

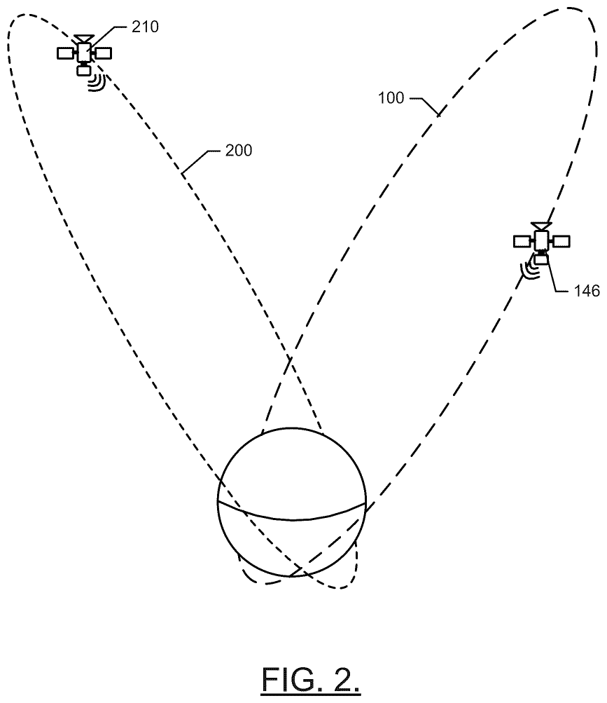

FIG. 2 illustrates the addition of a second orbital plane 200 in addition to the first orbital plane 100. For ease of display, only a single one of the four satellites of the first orbital plane 100 (i.e., the fourth satellite 146) is shown in the first orbital plane 100, and a fifth satellite 210 is shown in the second orbital plane 200. However, it can be appreciated that any number of additional satellites may be placed in each respective one of the first and second orbital planes 100 and 200 in various examples. Moreover, the number and spacing of the satellites will generally be selected to optimize connectivity and performance for a given deployment strategy. In this regard, the fewest number of satellites that can provide the highest quality and best efficiency will generally be preferred.

Some example embodiments may include the deployment of an operational system including as few as two or three orbital planes of four satellites each to achieve a total of 8 to 12 satellites in an initial operating system. Moreover, a single launch vehicle may carry small clusters of satellites so that deployment can be handled incrementally in stages to permit costs control and the most efficient possible rollout of service. Thereafter, augmenting launches of additional satellites may be scheduled and, as demand grows, the constellation may expand while carefully managing orbit timing and positioning to provide near-continuous coverage to key areas, and reduce latency to desired levels. Full coverage of the Earth 120 may be achieved with, for example, 8-12 planes of 4-6 satellites per plane (resulting in 32-72 satellites total), but this is far fewer than the hundreds or thousands of satellites that are needed for a LEO constellation. Using retrograde orbits, in isolation or in combination with prograde, can provide unique coverage patterns, reduce orbital slot congestion and interference coordination (especially making it easier to get regulatory approval or licenses), and can provide benefits in terms of launch-site selection.

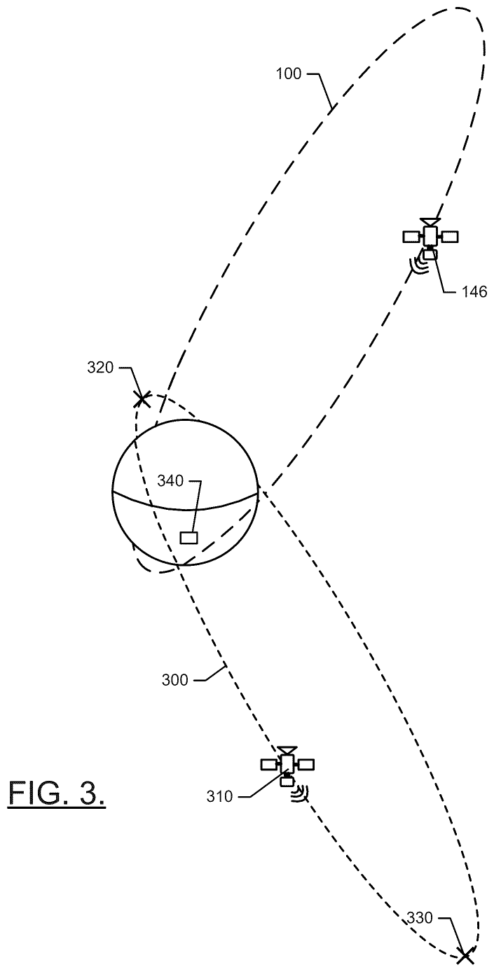

The first and second orbital planes 100 and 200 of FIG. 2 each have their perigee nearer the South Pole. However, other orbital planes can also be selected to have different perigee locations and satellites launched and deployed therein to meet desired needs and/or to provide global coverage instead of regional coverage. In this regard, FIG. 3 illustrates a third orbital plane 300 being employed with a sixth satellite 310 therein. Perigee 320 for the third orbital plane 300 is near the North Pole, and apogee 330 is therefore positioned to provide a long dwell time for the sixth satellite 310 for extended visibility to a second radio receiver 340 in the southern hemisphere.

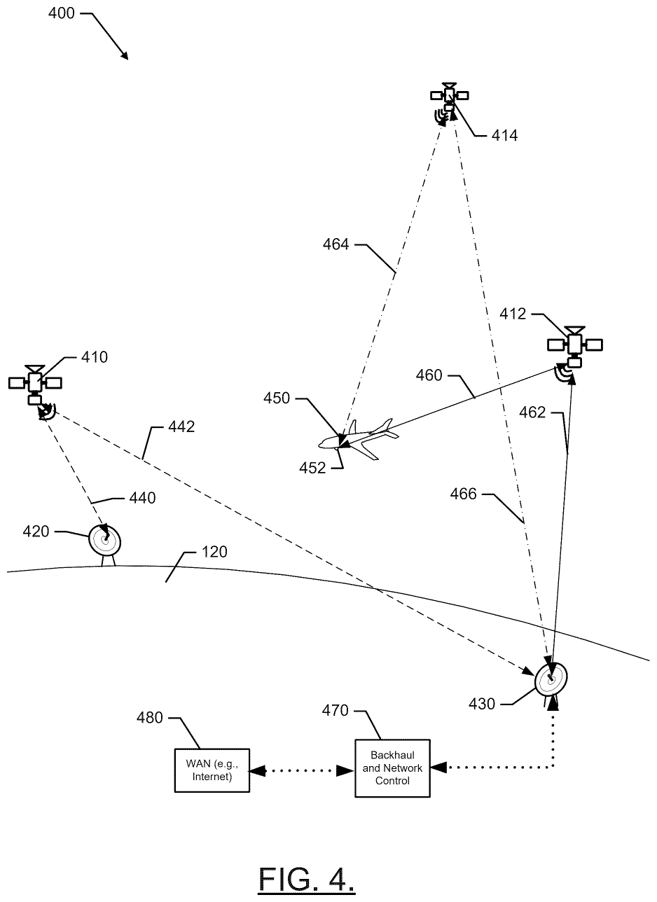

FIG. 4 illustrates a HEO satellite constellation system 400, which includes a first HEO satellite 410, a second HEO satellite 412, and a third HEO satellite 414. Of note, the system 400 may include many more HEO satellites, and each of the first, second, and third HEO satellites 410, 412 and 414, along with any additional HEO satellites, may be disposed in the same or different orbital planes. The first, second, and third HEO satellites 410, 412 and 414 may all include an onboard computer, one or more antennas, transponders, power systems (e.g., solar panels), attitude control systems, which include various sensors for determining proper physical orientation of the satellite, and thrusters for directional control. The attitude of the satellites must be controlled to ensure that the antennas are oriented correctly toward communications devices on the Earth 120. The first, second, and third HEO satellites 410, 412 and 414 may effectively act as relay stations for the communication devices at various points on the Earth 120. Thus, for example, a first communication device 420 may transmit a signal to the first HEO satellite 410 for ultimate reception at a second communication device 430. However, the first HEO satellite 410 can be replaced by, and/or hand off communications to the second or third HEO satellites 412 and 414

The communication link between the first communication device 420 and the first HEO satellite 410 may be considered to be an uplink 440 to the first HEO satellite 410. The communication link between the first HEO satellite 410 and the second communication device 430 may be considered to be a downlink 442. The first HEO satellite 410 may receive content via the uplink 440 transmission, amplify it and change its frequency before transmitting it on the downlink 442. In some cases, the first communication device 430 may be (or be located at) an uplink station. The uplink station may, for example, include or be a satellite phone, a satellite transponder, satellite antenna/dish, etc., which can be either fixed or mobile in various embodiments. The second communication device 430 may be a satellite receiving station or ground equipment including the same.

Although the first HEO satellite 410 may be moving in its orbit through its orbital plane, the long dwell time that can exist by virtue of the HEO path, may mean that the first HEO satellite 410 is the only satellite that is used for an entire communication session, which could last perhaps a few to several hours in length while the first and second communication devices 420 and 430 are both able to communicate with the first HEO satellite 410. However, if the communication session lasts long enough to risk losing sight of the first HEO satellite 410 at either the first or second communication device 420 and 430, then a handoff of the communication session (either hard or soft) may be conducted to a different satellite (e.g., the second or third HEO satellite 412 and 414). The handoff (or hand over) may be managed by a controller at the satellites and/or a controller located in a ground network (e.g., a terrestrial or fiber network).

In some cases, a communication device may, beyond merely being mobile, also not be on the ground. For example, an aircraft 450 may include a satellite transponder 452 including an antenna and other radio equipment for communication with, for example, the second HEO satellite 412. In such an example, an uplink 460 may be maintained between the aircraft 450 to the second HEO satellite 412 and a downlink 462 may be maintained between the second HEO satellite 412 and the second communication device 430. However, given the speed of movement of the aircraft 450, Doppler shift and other complicating issues, including more frequent handoffs, may be more prevalent, and may also have to be dealt with by the controller(s) managing handoff. After handoff to, for example, the third HEO satellite 414, uplink 464 may be between the aircraft 450 and the third HEO satellite 414, and downlink 466 may be between the third HEO satellite 414 and the second communication device 430.

As noted above, the second communication device 430 may be an entry point to a terrestrial or fiber network, which acts as a ground network. In an example embodiment, the second communication device 430 may be operably coupled to backhaul and network control components 470 that may provide routing and control services to enable the aircraft 450 or the first communication device 420, and any user equipment (UE) and other wireless communication devices thereon or in communication therewith, to communicate with a wide area network (WAN) 480 such as the Internet.

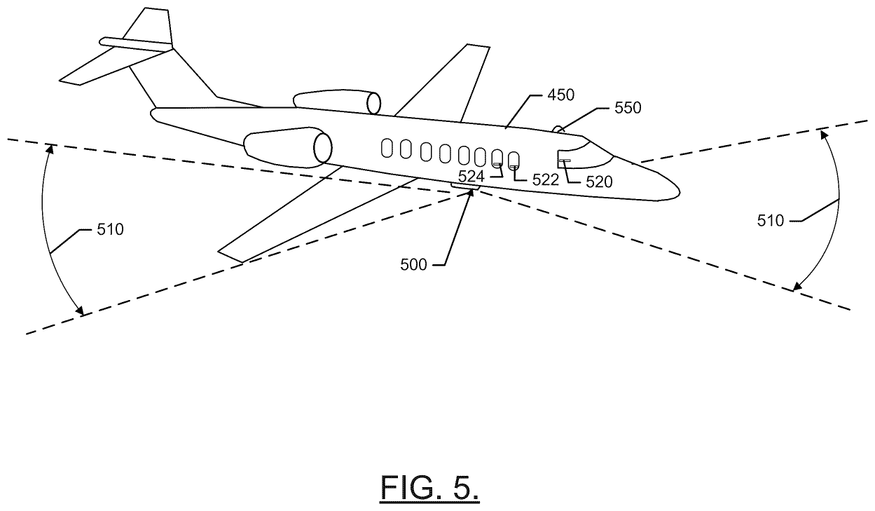

In some examples, the system 400 may be configured to incorporate horizon-facing antenna systems to enable or enhance frequency re-use. FIG. 5 illustrates such an example. In the example of FIG. 5, the aircraft 450 is shown in more detail. In this regard, for example, the satellite transponder 452 of FIG. 4 is specifically shown to include a belly mounted, blade antenna, which is a specific example of a directional antenna 500. The directional antenna 500 may be capable of generating a beam aperture 510 for receive and/or transmit that is aimed out toward the horizon instead of being either omni-directional, or pointing either generally upward or downward. The beam aperture 510 may have a limited area of focus aimed at the horizon to inhibit reception of signals above or below the aircraft 450. In some cases, the beam aperture 510 may extend 20 degrees, 40 degrees, or 60 degrees in total elevation, and may be centered in reference to a horizontal reference plane to ensure that the horizon is kept in view for any normal banking during turns implemented by the aircraft 450 in-flight. However, another center may be chosen in some cases.

As an alternative to using a belly mounted, or blade antenna as the directional antenna 500, antenna elements may be integrated into one or more windows or sides of the fuselage of the aircraft 450. In this regard, for example, individual antenna elements 520, 522 and 524 are shown in respective windows of the aircraft 450. The individual antenna elements 520, 522 and 524 may each operate at different frequencies, or may be controlled as part of an array to alter frequencies of operation using a controller on the aircraft 450.

Regardless of the specific approach used, placing antennas on the sides of aircraft (or within aircraft windows using transparent or embedded antenna materials) or on the aircraft's belly or roof using a more traditional looking blade antenna, with the antenna's primary focus being towards the horizon rather than more vertically overhead, may differentiate relative to current electronically steered antennas (ESAs). Recall the current ESA's purpose (in conjunction with the LEO satellite) is to minimize the skew angle, with the optimum signal strength coming from directly overhead and falling off from there, thus the ESA performs frequent hard or soft handoffs.

In an example embodiment in which horizon facing antennas on aircraft and ground stations are employed, the horizon facing antennas may provide a structural inhibition to receiving signals from the closest potential interference at a given operating frequency. Thus, receivers and transmitters generally will not transmit or receive signals in vertical orientations, where the distance to interference is least. Instead, by looking to the horizon (or, for example, ten to fifteen degrees above the horizon in some cases, or no more than twenty or thirty degrees above the horizon in others, or a maximum of 45 degrees in extreme cases, the only eligible satellites for communication will be those to which communication happens largely in a horizontal plane instead of in a vertical plane. This permits re-use of terrestrial frequencies without harmful interference while still not entirely giving up the advantages of the long dwell time of HEO satellites. In some examples, the satellites themselves may also have horizon facing antennas to further enforce the paradigm for avoidance of transmitting in vertical directions, and maximize the power transmissions instead in horizontal directions only, to maximize the opportunity for frequency re-use.

The horizon facing antenna system reduces complexity, computation, and power requirements relative to conventional ESAs because the HEO satellites spend extended time (i.e. ~3 hours) in relatively consistent horizon positions, minimizing “skew angle” issues and frequency of handoffs, relative to most population centers and/or flight paths (i.e. over the continental US, Europe, and Asia as examples). If used terrestrially, the same benefits would accrue. Thus, when considering use cases like on the lunar surface or on Mars where power may not be as plentiful as on Earth, this could make for more efficient antenna systems, even more so given there is reduced RF usage on these celestial bodies as compared to Earth.

As noted above, a horizon facing antenna architecture would also contribute greatly to the ability to do frequency re-use and thus harmonious spectrum sharing, making it much easier to discriminate a given frequency being used by terrestrial users in a given band with the use of the same band by an aviation user to a HEO satellite constellation. In this regard, for example, the common satellite RF spectrum used is in the C band, the Ka band, and the Ku band. These bands are generally dedicated to satellite communication usage, and therefore effectively limit the amount of total data that can be passed over the channels. Although taken together these bands provide a fair amount of bandwidth, that amount of bandwidth could be rapidly expanded if re-use of other frequencies otherwise used terrestrially could be re-used without interference. For example, unlicensed frequency bands (e.g., 2.4 GHz and 5.8 GHz) could be effectively used in a satellite communications context without interference to other communication devices on the ground by virtue of limiting the beam aperture 510. Different polarizations (e.g., vertical, horizontal, circular (left or right), etc.) can further isolate the signals from GPS or other incumbent systems. This fosters better spectral coexistence, especially in bands like L-band, S-band, C-band, or even unlicensed bands (2.4 GHz, 5.8 GHz).

For use in outerspace, or any locations where there aren't necessarily the same regulatory restrictions for radio frequency use as under jurisdiction in the airspace above individual countries, the opportunity exists to use custom power levels at varying frequencies to achieve objectives not possible when constrained by the regulations on Earth. Accordingly, for example, higher bandwidths and/or longer ranges may be achieved, both of which may be critical in Lunar and Martian constellations, along with use in relay applications between Earth, Lunar, and/or Martian orbits.

In an architecture employing horizon facing antennas, an important consideration is latitude. In this regard, certain latitude limits may be prescribed such that being between certain latitude limits near the equator for orbital planes with perigee at the poles, blockage of the Earth 120 may exist for a larger number of the HEO satellites. To handle the perigee latitude-induced coverage gap, while using horizon facing antennas, one solution may be to use the HEO satellites that are visible near the equator and do handoffs before they lose line of sight. As an example, if an observer on the ground is at 19° N, then the observer would be able to see a satellite directly over the North Pole right at the horizon if the satellite was at 8,200 miles altitude. Given the perigees anticipated in one embodiment of the HEO design are on the order of 300-600 miles above the pole, the HEO sat in the orbital plane that was at or near perigee would not be visible to the observer and thus the other visible satellites in the plane would need to be used. The backhaul and network control components 470 may include a controller to track satellite locations relative to aircraft (or other communication devices) location in order to manage the handoffs strategically, although it may be understood that more rapid handoffs may occur at latitudes closer to the equator.

Another way to handle the perigee latitude-induced coverage gap is to take advantage of the more favorable radio link budget at perigee and augment the horizon facing design with an additional antenna that can receive overhead signals. FIG. 5 illustrates a top mounted antenna 550 that may be used for this purpose. The top mounted antenna 550 may also be an ESA, or may alternatively be an omni-directional antenna with clear line of sight directly overhead, +/−60 degrees. The link budget is favorable at perigee because i) the distance is the closest between the HEO satellite and the communication device (e.g., terrestrial and/or aviation communication node) and ii) for spectrum re-use scenarios like that with the unlicensed band (or re-use of licensed terrestrial spectrum), there is such little population of users above the Arctic or Antarctic circle that signal interference, demand, and congestion are all at a minimum.

In an example embodiment, the top mounted antenna 550 may only selectively be employed when needed. Thus, for example, only if there is not handover candidate that is accessible via the horizon facing array of antennas, the top mounted antenna 550 may be called into service. This may even be true in relation to integrating the HEO satellite constellation with another satellite constellation (e.g., GEO) for a combined HEO and GEO (or GHEO) constellation. In such a case, for example, the third HEO satellite 414 of FIG. 4 may not be a HEO satellite and instead a GEO satellite (although it could alternatively be LEO or MEO as well). The top mounted antenna 550 may then be turned on and used to utilize communication in a hybrid fashion with the GEO (or MEO or LEO) constellation to conduct a hybrid handoff and maintain communication through a handoff between different types of satellites. The top mounted antenna 550 could be duplicated on ships, oil rigs, or any other ground station as well, along with horizontal facing antennas to hybridize horizon facing and non-horizon facing antenna alternatives to enhance coverage.

Rough limiting latitudes in order to have line of sight to a satellite at a given altitude over the North Pole (same would be true in reverse for the South Pole) include those of Table 1 below:

TABLE 1

| Satellite Altitude (miles) | ~Latitude (°N) |
|---|---|
| 300 | 68.7 |
| 600 | 60.3 |
| 1,000 | 52.9 |
| 3,000 | 34.7 |
| 6,000 | 23.4 |
| 9,000 | 17.7 |
| 23,500 | 8.3 |

Table 1 illustrates that, for example, at a point in time when a HEO satellite has an altitude over the North Pole of 1,000 miles, then the HEO satellite would have line of sight from the North Pole down to 52.9 N latitude, but would not have line of sight to latitudes below that (at that time).

The system 400 may also be extended, or largely duplicated, for applications including lunar and Martian constellations. Thus, for example, the Earth 120 of FIGS. 1 and 2 could instead be replaced with the Moon or Mars. Adapting the HEO design to these celestial bodies, the HEO satellites may not only communicate in a similar fashion to that described above for Earth 120, but relaying of information between constellations may also be provided. Thus, a Lunar constellation may relay communications from a Martian constellation to a constellation at the Earth 120. Given the future importance of communications on these celestial bodies, yet desiring to keep the complexity low, a LEO design for the Moon or Mars would be very costly and unnecessary. The HEO architecture could be used for a fraction of the cost with most of the same benefits. Further, the HEO satellites could be equipped to provide more than communications, examples include power beaming or solar reflection to otherwise dark regions (e.g., the Moon's far side).

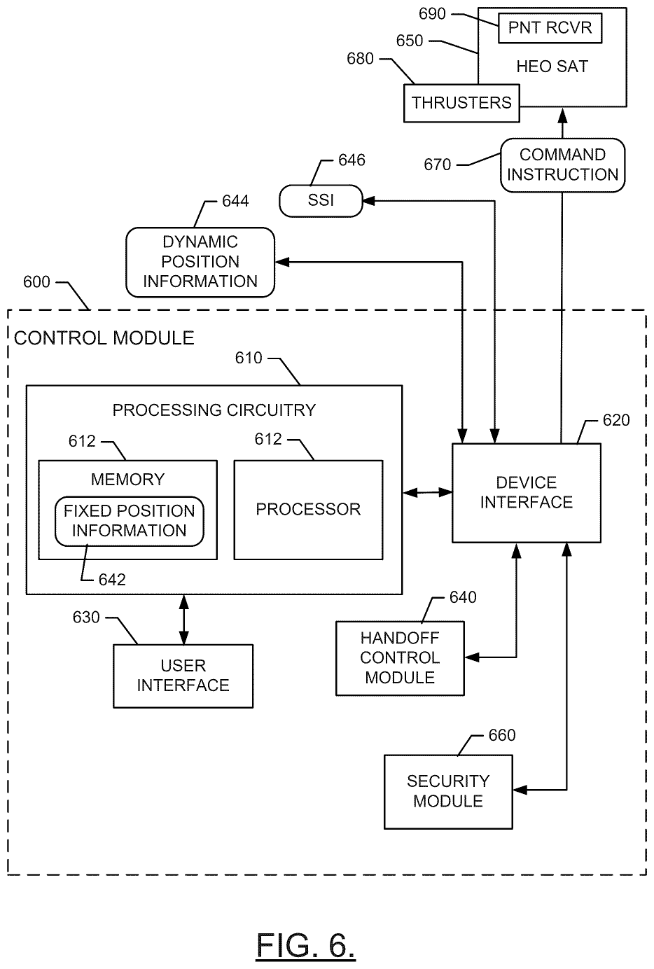

As noted above, handoff of a communication device (e.g., the first communication device 420 or the aircraft 450) between HEO satellites may be controlled either at the device being handed off and/or at the controller of the backhaul and network control components 470. FIG. 6 illustrates an example implementation of such a controller. In this regard, for example, the backhaul and network control components 470 may include one or more instances a control module 600. The control module 600 may include processing circuitry 610 configured to provide control outputs for generation of instructions for devices in communication therewith to facilitate the provision of continuous communications within the system 400. The processing circuitry 610 may be configured to perform data processing, control function execution and/or other processing and management services according to an example embodiment. In some embodiments, the processing circuitry 610 may be embodied as a chip or chip set. In other words, the processing circuitry 610 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 610 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 610 may include one or more instances of a processor 612 and memory 614 that may be in communication with or otherwise control a device interface 620 and, in some cases, a user interface 630. As such, the processing circuitry 610 may be embodied as a circuit chip (e.g., an integrated circuit chip) configured (e.g., with hardware, software or a combination of hardware and software) to perform operations described herein. However, in some embodiments, the processing circuitry 610 may be embodied as a portion of a server or other computer. In some embodiments, the processing circuitry 610 may communicate with various components, entities and/or sensors of the system 400.

The user interface 630 (if implemented) may be in communication with the processing circuitry 610 to receive an indication of a user input at the user interface 630 and/or to provide an audible, visual, mechanical or other output to the user. As such, the user interface 630 may include, for example, a display, touchscreen, one or more levers, switches, indicator lights, keyboard, buttons or keys (e.g., function buttons), and/or other input/output mechanisms.

The device interface 620 may include one or more interface mechanisms for enabling communication with other devices (e.g., modules, entities, sensors and/or other components of the system 400). In some cases, the device interface 620 may be any means such as a device or circuitry embodied in either hardware, or a combination of hardware and software that is configured to receive and/or transmit data from/to modules, entities, sensors and/or other components of the system 400 that are in communication with the processing circuitry 610.

The processor 612 may be embodied in a number of different ways. For example, the processor 612 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 612 may be configured to execute instructions stored in the memory 614 or otherwise accessible to the processor 612. As such, whether configured by hardware or by a combination of hardware and software, the processor 612 may represent an entity (e.g., physically embodied in circuitry—in the form of processing circuitry 610) capable of performing operations according to embodiments of the present invention while configured accordingly. Thus, for example, when the processor 612 is embodied as an ASIC, FPGA or the like, the processor 612 may be specifically configured hardware for conducting the operations described herein. Alternatively, as another example, when the processor 612 is embodied as an executor of software instructions, the instructions may specifically configure the processor 612 to perform the operations described herein.

In an example embodiment, the processor 612 (or the processing circuitry 610) may be embodied as, include or otherwise control the operation of the control module 600 based on inputs received by the processing circuitry 610 responsive to receipt of signals and/or information from an antenna of the second communication device 430 of FIG. 4. As such, in some embodiments, the processor 612 (or the processing circuitry 610) may be said to cause each of the operations described in connection with the control module 600 in relation to adjustments to be made to operation of the system 400 including handoff and other functions.

In an exemplary embodiment, the memory 614 may include one or more non-transitory memory devices such as, for example, volatile and/or non-volatile memory that may be either fixed or removable. The memory 614 may be configured to store information, data, applications, instructions or the like for enabling the processing circuitry 610 to carry out various functions in accordance with exemplary embodiments of the present invention. For example, the memory 614 could be configured to buffer input data for processing by the processor 612. Additionally or alternatively, the memory 614 could be configured to store instructions for execution by the processor 612. As yet another alternative, the memory 614 may include one or more databases that may store a variety of data sets responsive to signal reception and/or interaction with the HEO satellites (e.g., HEO satellite 650) of the system 400. Among the contents of the memory 614, applications and/or instructions may be stored for execution by the processor 612 in order to carry out the functionality associated with each respective application/instruction. In some cases, the applications may include instructions for providing inputs to control operation of the control module 600 as described herein.

In an example embodiment, the memory 614 may store a body of fixed position information 642 or portions thereof. The fixed position information 642 may provide the locations of any entities of the system 400 that are not mobile. The memory 614 may also be used to store dynamic position information 644 and/or signal strength information (SSI) 646 that may either be received or computed relating to the various moving entities within the system 400. The SSI 646 may include indicators of noise, quality, channel capacity, or any other parameters that relate to the performance of communication channels associated with uplinks and/or downlinks that may be used to make handoff decisions. The dynamic position information 644 may indicate where in the HEO orbital path of the HEO satellite 650 and/or various other HEO satellites are located and/or where various communication assets (e.g., including the aircraft 450) are located either in absolute terms or relative to each other. The dynamic position information 644, SSI 646 and fixed position information 642 may be used by a handoff control module 640 to instruct handoff to maintain communications sessions through such handoff. In this regard, for example, the handoff control module 640 may be configured to determine when a particular HEO satellite will go out of view of the aircraft 450, and therefore also determine by when a handoff to another HEO satellite will be required to maintain connectivity. Alternatively or additionally, the handoff control module 640 may determine from the SSI 646 that channel quality is below an acceptable threshold (or a handoff threshold) for a particular HEO satellite, and then attempt to locate another HEO satellite to which connectivity can be handed over.

As noted above, each satellite in HEO can dwell over a targeted region for roughly 1-3 hours in a quasi-LEO zone (~6,000 miles altitude down to perigee). During this window, free-space latency can be under ~50-100 ms each way, providing a maximum roundtrip near or below 250 ms even when factoring in typical network routing times. HEO Handovers occur less frequently than in a typical LEO constellation, because each HEO satellite remains in view for extended periods. By using multiple orbital planes and staggering their perigees/apogees it may be possible to ensure focused coverage over a desired region. Literally any given spot on Earth can be picked for perigee by adjusting the argument of perigee and right ascension of the ascending node (RAAN), to augment the orbital characteristics as desired relative to the location of the traffic one is trying to optimize service for. Accordingly, it may be possible to adjust the selection of orbital parameters to have the perigee occur over North America, as an example. Because real orbits experience gravitational perturbations, especially due to Earth's oblateness, the 63.4 degree inclination is often used for Molniya orbits to minimize the ‘argument-of-perigee’ drift. Different inclinations would result in the need for small station-keeping maneuvers to preserve the desired long term orbital geometry.

In some embodiments, the control module 600 may also include a security module 660, which may be used to provide secure communications via the uplinks and/or downlinks that are established in the system 400. In this regard, the security module 660 may, for example, provide a command instruction 670 to the HEO satellite 650. The command instruction 670 may instruct the HEO satellite 650 to initiate a change to its orbit, which may be accomplished by activating thrusters 680.

In this regard, in some example embodiments, the HEO satellite 650 and/or the aircraft 450 (or other communication device) may include a position, navigation and timing (PNT) receiver 690. The PNT receiver 690 may, for example, use Global Navigation Satellite System (GNSS) or other navigation system technologies that enable position navigation and timing capabilities to be used in connection with various aspects of control. In particular, the PNT receiver 690 may enable precise location information of either or both of the HEO satellite 650 and the aircraft 450 to be used to implement physical cryptography. For example, purposely making micro-orbit adjustments to the HEO satellite 650 for security, signals can be authenticated by making minute changes in orbital timing (e.g., via applying a short burst of thrust to the thrusters 680 via the command instruction 670 to alter the orbit in a way that would be perceptible at the nanosecond level, but not otherwise readily visible or noticeable). The operator of the system 400 may therefore insert micro-orbit adjustments as known changes, and apply these known changes to the constellation owner/user base. These changes would otherwise be difficult to externally detect by adversaries in real-time, which would make them an excellent means of detecting spoofing or jamming. In a single nanosecond, a radio signal travels about 1 foot. So altering the orbit by 10 feet would cause a 10 nanosecond difference in a positioning signal. Many modern high quality PNT receivers can achieve tens of nanoseconds of accuracy or better (10-40 ns), so a 10-40 foot change in orbit could be readily accomplished with a minimal amount of thrust yet would be detectable as a difference by the PNT receiver 690. Example embodiments may therefore be used to provide an alternative to conventional PNT methods, which may create opportunities to adjust timings of signals for position determination, enhanced security of communication, or other uses.

In an example embodiment, the changes instituted by the security module 660 may be calculated to create a perceptible change of a fixed amount at a location that is known only to authorized users of the communications being exchanged. Thus, for example, after a micro-orbit change is made to a satellite that will cause a corresponding known shift in timing perceived by a desired/authorized recipient, only communications having the corresponding known shift in timing may thereafter be accepted as authentic communications. Additionally or alternatively, desired/authorized recipients may receive a challenge to report the timing change experienced, and only those that report the correct timing change in reply may be accepted as authorized communicators over the corresponding channel. Others may be recognized as spoofing or otherwise attempting unauthorized use of the system 400.

Another extended application may be latency-based cryptography. Besides the PNT aspects discussed above, a cryptography signal could be based on the actual latency of the received signal from the HEO satellite 650, which is constantly varying due to the orbit. In the case of micro-orbit adjustments, the micro-adjustments would enable unnatural variations in latency to be injected into the system as a means to help distinguish friend from foe, or as part of a key for cryptographic purposes. If combining prograde and retrograde orbits, then the satellites can come relatively close in space on a predictable but short-lived schedule, which may allow for brief, secure inter-satellite communications that would be difficult to intercept by a ground-based adversary. With a properly timed passing intersection, the constellation can exchange data in a way to lower the probability of detection or jamming.

Another extended application may be hybrid physical and virtual latency adjustments. In combination with the orbit varying approach, small latency adjustments could be injected into the data processing system on the satellite or ground system to further the latency-based cryptography approach and potentially reduce the level of physical orbital adjustment that is required, along with its attendant impacts on satellite power.

Yet another extended application may be physical satellite security. In this regards, because of the unique orbit of HEO, it is a much more challenging orbital mechanics problem to intercept a HEO satellite. If an anti-HEO satellite launch was detected, it would take just a small amount of thrust by the thrusters 680 of the HEO satellite 650 to make an orbital adjustment (post anti-satellite launch) to eliminate or minimize the pre-launch probability of intercept, given the very precise timing required to succeed with a HEO intercept given the speeds involved and intercepting rocket energy requirements. Thus, for critical space-based infrastructure, the HEO concept can be used to enhance resistance to anti-satellite weaponry. Further, if a retrograde orbit is used, it is less predictable to adversaries as it is uncommon and most have not deployed extensive tracking resources in that inclination. If an adversary were to disrupt the prograde orbital plane satellites, the retrograde plane would remain unaffected adding to resilience of the overall system. Still another extended application may include environmental and remote sensing. In this regard, for example, extended dwell times, whether they are the LEO-like dwell times near perigee or the GEO-like dwell times near apogee, can be leveraged for polar weather tracking, atmospheric gas sensing, or other Earth observation needs. By optimizing orbit architecture and introducing horizon-facing antennas, micro-adjustments for security, and easily scalable deployment, the control module 600 of example embodiments may stand apart from conventional LEO/MEO/GEO or older Molniya-based constellations.

Accordingly, satellite survivability may be enhanced by example embodiments. In this regard, the orbit-based micro-adjustments described above may form an additional layer of security (akin to a second-factor authentication) for users. Coupled with standard encryption, blockchain-based record-keeping, or AI-based anomaly detection, the system may provide robust protection against jamming or spoofing attacks. For instance, a blockchain could be used to have a record of actual latency history to ensure the signal is valid, as compared to just having access to the real-time signal from a HEO satellite itself. There could also be a reference ground location used to create and then apply a system-wide correction to the calculated position without requiring direct knowledge of the latency adjustment. HEO orbits are also less predictable to external observers if maneuvered sporadically, which can mitigate threats from anti-satellite weapons. Temporary “off-coverage” from certain ground sensors can be exploited to alter the orbit discreetly, increasing interception difficulty.

Orbital parameter selection can be controlled by the control module 600 to fire the thrusters 680 to make other desired changes via the command instruction 670 as well. Thus, for example, if it was desirable to have a perigee pass over North America, the control module 600 may be used to select an inclination of the HEO satellite 650 that is suitable for coverage or dwell time goals, and then adjust the argument of perigee and RAAN to have perigee line up physically over a spot in North America. Thereafter, the control module 600 may issue instructions to set the orbital period (through the semi-major axis) and eccentricity to achieve the desired dwell time and coverage footprint.

Notably, in connection with Lunar and/or Martian deployments, or relaying deployments, it may be possible to choose orbital parameters that allow HEO satellites to “see” both near and far sides of the Moon. Such a system can provide continuous relay for exploration, resource extraction, or even power beaming. A satellite in a highly elliptical lunar orbit can dwell over a region to facilitate sustained communication with minimal ground infrastructure. Similar orbital principles can be applied to Mars, offering a cost-effective solution to maintain communication and data relay for rovers, human outposts, or sensor networks across the planet's surface.

In connection with relaying secure communications between Earth and a Lunar or Martian HEO, a retrograde orbit around Earth might intersect with prograde orbits around the Moon or Mars at planned intervals, acting as a short secure corridor for data relays. The retrograde Earth HEO might, in turn, align better with a specialized transfer orbit for relaying or conducting Earth-Moon or Earth-Mars communications. At points of high altitude, a satellite could also deploy a reflective mirror to direct sunlight onto permanently shaded lunar craters, supporting solar-power collection in regions otherwise starved of direct sunlight. Example embodiments may also be employed for maintaining vantage points that are ideal for observing polar regions, tracking ice coverage, weather patterns, and atmospheric changes. The long dwell times of example embodiments may also support high-resolution and/or persistent imaging campaigns, beneficial for monitoring deforestation, pollution, carbon emissions, and climate changes. Some example embodiments may also be employed for broadband and emergency response in rural or disaster areas. For example, by adjusting coverage areas through command instructions, rapid re-deployable coverage can be achieved over disaster areas (e.g., for hurricanes, wildfires, etc.) to ensure reliable, uninterrupted broadband, facilitating emergency communications and data collection.

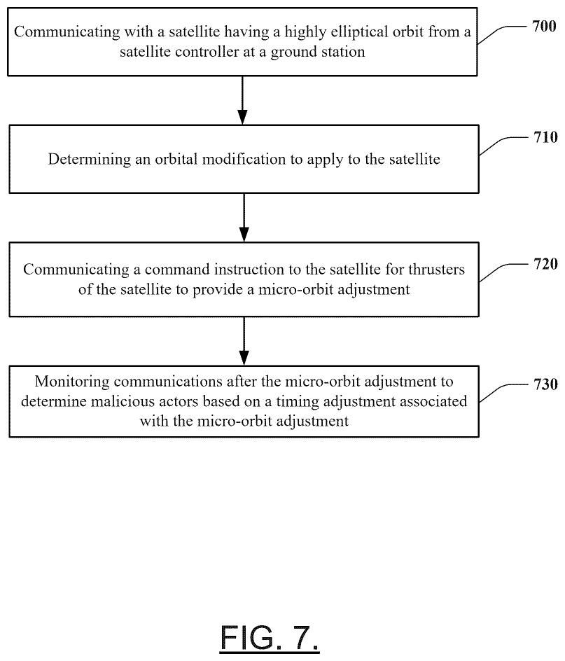

From a technical perspective, the control module 600 described above may be used to support a method of applying enhanced communication security in a satellite communication environment. As an example, FIG. 7 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a device and executed by a processor in the device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method of applying enhanced communication security in a satellite communication environment according to one embodiment of the invention, as shown in FIG. 7, may include communicating with a satellite having a highly elliptical orbit from a satellite controller at a ground station at operation 700. The method may further include determining an orbital modification to apply to the satellite at operation 710 and communicating a command instruction to the satellite for thrusters of the satellite to provide a micro-orbit adjustment at operation 720. The method may further include monitoring communications after the micro-orbit adjustment to determine malicious actors based on a timing adjustment associated with the micro-orbit adjustment at operation 730.

Accordingly, a satellite communication system of an example embodiment may include a first satellite among a constellation of satellites, where the first satellite has a first HEO with a first apogee and a first perigee. The system may also include a second satellite among the constellation of satellites, where the second satellite has a second HEO with a second apogee and a second perigee. The system may also include a first communication device capable of communicating with the first or second satellite via a first communication link, a second communication device capable of communicating with the first or second satellite via a second communication link and being operably coupled to backhaul and network control components, and a satellite controller operably coupled to the first and second satellites via the second communication device to provide a command instruction to either or both of the first and second satellites to manage a handoff of the first communication device between the first and second satellites or modify an orbit of a respective one of the first or second satellites.

In some embodiments, the system may include additional, optional features, and/or the features described above may be modified or augmented. Some examples of modifications, optional features and augmentations are described below. It should be appreciated that the modifications, optional features and augmentations may each be added alone, or they may be added cumulatively in any desirable combination. In an example embodiment, the satellite controller may include a handoff control module configured to provide control of the handoff of the first communication device between the first and second satellites based on position information and/or signal strength information. In an example embodiment, a security module may determine the command instruction, and the command instruction may instruct the first satellite or the second satellite to ignite thrusters to initiate a micro-adjustment to an orbit of the first satellite or the second satellite. In some cases, the micro-adjustment to the orbit may enable the security module to perform time-of-flight authentication for anti-spoofing. In an example embodiment, the micro-adjustment to the orbit may enable the security module to introduce timing variations not replicable by a malicious transmitter. In some cases, the micro-adjustment to the orbit may enable the security module to use computational timing variations in combination with timing variations associated with the micro-adjustment to introduce timing variations not replicable by a malicious transmitter. In an example embodiment, the first apogee and first perigee is different from the second apogee and second perigee, respectively, in order to define satellite dwell times, coverage areas and latency parameters for the first and second satellites, respectively, that are dependent on latitude. In some cases, the first communication device may include a horizon facing antenna array with a limited beam width directed toward the horizon. In an example embodiment, the antenna array may be formed in windows or a side of a fuselage of an aircraft. In some cases, the antenna array may be disposed at an underside of a fuselage of an aircraft to prevent communication with satellites above the aircraft. In an example embodiment, a top mounted antenna may be disposed at top of the aircraft to selectively provide visibility of the first satellite responsive to a need for a handover from the second satellite when the first satellite is no oriented toward the horizon relative to the aircraft. In some cases, the antenna array may employ a same RF frequency as a terrestrial wireless communication network without interfering with the terrestrial wireless communication network based due to the horizon facing nature of the antenna array. In an example embodiment, a security module determines the command instruction, and the command instruction may employ blockchain techniques for enhanced security. In some cases, the first satellite has a prograde orbit and the second satellite has a retrograde orbit. In an example embodiment, the first HEO and the second HEO are both defined to be Earth-centric, Lunar-centric, or Martian-centric. In some cases, the first HEO is defined to be Earth-centric, Lunar-centric, or Martian-centric, and the second HEO is defined to be a different one of Earth-centric, Lunar-centric, or Martian-centric than the first HEO and communications are relayed between the first and second satellites. In an example embodiment, the system may further include a third satellite in a geostationary orbit, a medium earth orbit, or a low earth orbit, and the third satellite is further enabled to handoff communications with the first and second satellites. In some cases, the first satellite or the second satellite employs a PNT receiver. In an example embodiment, the satellite controller employs time-of-flight authentication for anti-spoofing. In some cases, the first HEO lies in a first orbital plane with the first perigee selected to target coverage of a specific land region or body of water, and the second HEO lies in a second orbital plane, different than the first orbital plane, with the second perigee also selected to target coverage of the specific land region or body of water.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A satellite communication system comprising:
a first satellite among a constellation of satellites, the first satellite having a first highly elliptical orbit (HEO) with a first apogee and a first perigee;
a second satellite among the constellation of satellites, the second satellite having a second HEO with a second apogee and a second perigee;
a first communication device capable of communicating with the first or second satellite via a first communication link;
a second communication device capable of communicating with the first or second satellite via a second communication link, the second communication device being operably coupled to backhaul and network control components; and
a satellite controller operably coupled to the first and second satellites via the second communication device to provide a command instruction to either or both of the first and second satellites to manage a handoff of the first communication device between the first and second satellites or modify an orbit of a respective one of the first or second satellites.

2. The system of claim 1, wherein the satellite controller comprises a handoff control module configured to provide control of the handoff of the first communication device between the first and second satellites based on position information and/or signal strength information.

3. The system of claim 1, wherein a security module determines the command instruction, and wherein the command instruction instructs the first satellite or the second satellite to ignite thrusters to initiate a micro-adjustment to an orbit of the first satellite or the second satellite.

4. The system of claim 3, wherein the micro-adjustment to the orbit enables the security module to perform time-of-flight authentication for anti-spoofing.

5. The system of claim 3, wherein the micro-adjustment to the orbit enables the security module to introduce timing variations not replicable by a malicious transmitter.

6. The system of claim 3, wherein the micro-adjustment to the orbit enables the security module to use computational timing variations in combination with timing variations associated with the micro-adjustment to introduce timing variations not replicable by a malicious transmitter.

7. The system of claim 1, wherein the first apogee and first perigee is different from the second apogee and second perigee, respectively, in order to define satellite dwell times, coverage areas and latency parameters for the first and second satellites, respectively, that are dependent on latitude.

8. The system of claim 1, wherein the first communication device includes a horizon facing antenna array with a limited beam width directed toward the horizon.

9. The system of claim 8, wherein the antenna array is formed in windows or a side of a fuselage of an aircraft, or
wherein the antenna array is disposed at an underside of a fuselage of an aircraft to prevent communication with satellites above the aircraft.

10. The system of claim 9, wherein a top mounted antenna is disposed at top of the aircraft to selectively provide visibility of the first satellite responsive to a need for a handover from the second satellite when the first satellite is no oriented toward the horizon relative to the aircraft.

11. The system of claim 8, wherein the antenna array uses a same RF frequency as a terrestrial wireless communication network without interfering with the terrestrial wireless communication network based due to the horizon facing nature of the antenna array.

12. The system of claim 1, wherein the first HEO lies in a first orbital plane with the first perigee selected to target coverage of a specific land region or body of water, and
wherein the second HEO lies in a second orbital plane, different than the first orbital plane, with the second perigee also selected to target coverage of the specific land region or body of water.

13. The system of claim 1, wherein a security module determines the command instruction, and wherein the command instruction employs block chain techniques for enhanced security.

14. The system of claim 1, wherein the first satellite has a prograde orbit and the second satellite has a retrograde orbit.

15. The system of claim 1, wherein the first HEO and the second HEO are both defined to be Earth-centric, Lunar-centric, or Martian-centric.

16. The system of claim 1, wherein the first HEO is defined to be Earth-centric, Lunar-centric, or Martian-centric, and the second HEO is defined to be a different one of Earth-centric, Lunar-centric, or Martian-centric than the first HEO and communications are relayed between the first and second satellites.

17. The system of claim 1, further comprising a third satellite in a geostationary orbit, a medium earth orbit, or a low earth orbit, and the third satellite is further enabled to handoff communications with the first and second satellites.

18. The system of claim 1, wherein the first satellite or the second satellite employs a positioning, navigation and timing (PNT) receiver.

19. The system of claim 1, wherein the satellite controller employs time-of-flight authentication for anti-spoofing.

20. A method of applying enhanced communication security in a satellite communication environment, the method comprising:
communicating with a satellite having a highly elliptical orbit from a satellite controller at a ground station;
determining an orbital modification to apply to the satellite;
communicating a command instruction to the satellite for thrusters of the satellite to provide a micro-orbit adjustment; and
monitoring communications after the micro-orbit adjustment to determine malicious actors based on a timing adjustment associated with the micro-orbit adjustment.
